(19) United States
(12) Patent Application Publication
(10) Pub. No.: US 2015/0280365 A1
(43) Pub. Date: Oct. 1, 2015

(54) COLLAPSIBLE PLUG WITH EXTRACTION COMPONENT

(71) Applicant: VOLEX plc, London (GB)

(72) Inventors: Boon Leng Allen Lim, Singapore (SG); Mui Lian Jessica Toh, Singapore (SG)

(21) Appl. No.: 14/670,311

(22) Filed: Mar. 26, 2015

Related U.S. Application Data
(60) Provisional application No. 61/970,513, filed on Mar. 26, 2014.

(51) Int. Cl. H01R 13/633; H01R 13/502

(52) U.S. Cl. CPC H01R 13/6335; H01R 13/502

(57) ABSTRACT

An electrical plug having an extraction component that may be collapsed to decrease the profile of the plug and may be retracted to increase the profile of the plug. Increasing the profile of the plug increases the graspable area of the plug, making it easier to extract the plug from an outlet socket. The extraction component may be a slidable cover substantially surrounding a housing holding the pins and wiring of the plug within an overmold. The extraction component may also be a slidable cap connected to a pin bridge surrounded by an overmold. Openings formed within the pin bridge include a stopper that limits the retraction of the extraction component. The extraction components include a number of snap-fit pins that are each inserted into the openings beyond the stoppers, at which point the snap-fit ends of the pins expand and hold pins within the openings.

### CROSS REFERENCE TO RELATED APPLICATIONS

This application claims benefit under 35 U.S.C. §119(e) of Provisional U.S. patent application No. 61/970,513, filed Mar. 26, 2014, the content of which is incorporated herein by reference in its entirety.

### TECHNICAL FIELD

The present disclosure relates to low profile collapsible electrical plugs.

### BACKGROUND

Common alternating current (AC) power plugs for electrical appliances are of a straight type where the pins of the plug are substantially parallel in orientation to the electrical conductor cable terminating at the plug. Straight plugs are sufficient for most applications as space for the plug and cable are not at a premium. However, in some cases, the appliance is located very close to a wall containing the outlet socket into which the plug is to be inserted, or the appliance is mounted on an object, such as a desk, that provides little space between the desk and the wall containing the outlet socket. In such cases, space saving solutions are desired.

One known solution is to use a slim or flat plug design that reduces the size of the plug extending from the wall outlet socket, without sacrificing the basic functions of the plug. Examples of these types of plugs can be found in U.S. Pat. Nos. 4,927,376, 5,057,036, and 5,454,731. FIG. 1 illustrates the electrical plug assembly disclosed in U.S. Pat. No. 4,927,376. FIG. 2 illustrates the low profile electrical plug disclosed in U.S. Pat. No. 5,454,731.

Slimming the profile of the plug, however, provides the user with less of a housing to grab with their fingers in order to remove the plug from an outlet socket, which can make slim plugs less desirable to many users. One solution for addressing this problem is illustrated by the plastic removal handle 22 of FIG. 2, which assists a user in removing the plug 20 from an outlet socket. The removal handle is hinged by hinge 24 so that the handle can be stored when not in use by fitting its opening over the reinforcing portion 26. The handle is then locked in its stored position by locking flange 28. The arrangement of the hinged handle may present durability issues associated with the hinge and the fact that hinging the handle may cause the plug 20 to be pulled at from an angle, which can cause uneven wear issues within the plug. In addition, the relatively small size of the plug 20 means that the handle 22 is relatively small and the hole within the handle, in which a user may attempt to insert a finger, is even smaller, which may be an issue for users with larger fingers.

### SUMMARY

An electrical plug having an extraction component is disclosed. The plug is assembled so the extraction component may be collapsed against the remainder of the plug when not in use, so as to decrease the profile of the plug, and may be partly pulled away from the plug when in use so as to increase the profile of the plug. Increasing the profile of the plug increases the graspable area of the plug, making it easier to extract the plug from an outlet socket. In one embodiment, the extraction component is a slidable cover substantially surrounding the periphery of a housing holding the pins and wiring of the plug within an overmold. In a second embodiment, the extraction component is a slidable cap connected to a pin bridge that is surrounded by an overmold. A number of openings are formed within the pin bridge, each opening including a stopper that limits the retraction of the extraction component. The extraction component includes a number of snap-fit pins that are each inserted into the openings beyond the stoppers, at which point the snap-fit ends of the pins expand and hold pins within the openings.

### BRIEF DESCRIPTION OF THE DRAWINGS

Throughout the drawings, reference numbers may be re-used to indicate correspondence between referenced elements. The drawings are provided to illustrate examples described herein and are not intended to limit the scope of the disclosure.

FIG. 1 is a PRIOR ART illustration of a plug disclosed in U.S. Pat. No. 4,927,376.

FIG. 2 is a PRIOR ART illustration of a low profile electrical plug disclosed in U.S. Pat. No. 5,454,731.

FIG. 3 is an illustration of plug having an extraction component in accordance with an embodiment.

FIG. 4 is an illustration of plug having an extraction component in accordance with an embodiment.

FIG. 5A illustrates a profile of the plug of FIG. 3 when collapsed and retracted.

FIG. 5B illustrates a profile of the plug of FIG. 4 when collapsed and retracted.

FIG. 6 is an exploded view of the plug illustrated in FIG. 3.

FIGS. 7A, 7B, 7C, 7D, 7E, and 7F illustrate an embodiment of assembly steps for the plug illustrated in FIG. 6.

FIG. 8 is a partially exploded view of the plug illustrated in FIG. 4.

FIGS. 9A, 9B, and 9C illustrates as embodiment of assembly steps for the plug illustrated in FIG. 8.

FIG. 10A is a side view of the extraction component of FIG. 9.

FIG. 10B are cross-sectional illustrations of the plug of FIG. 4 in the collapsed and the retracted position.

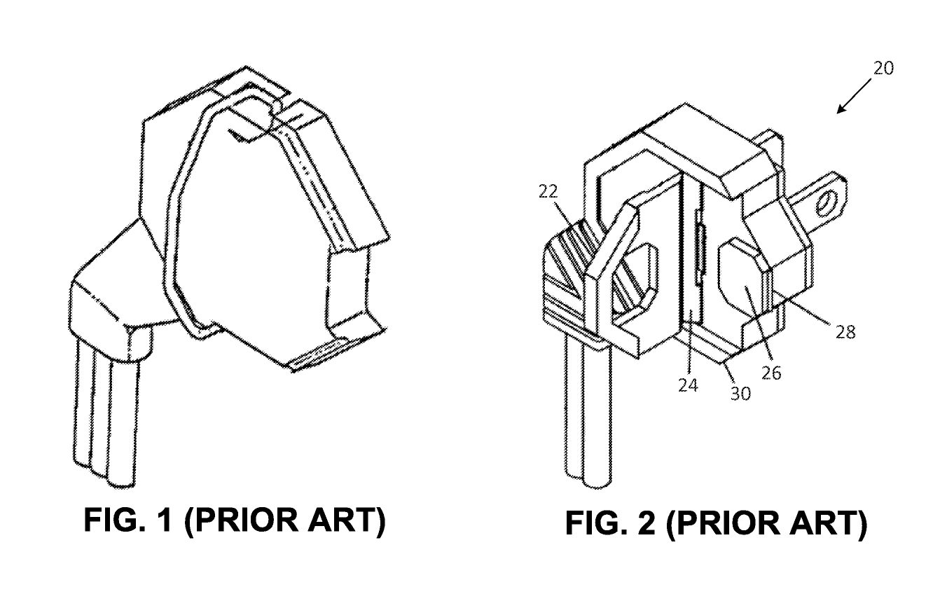

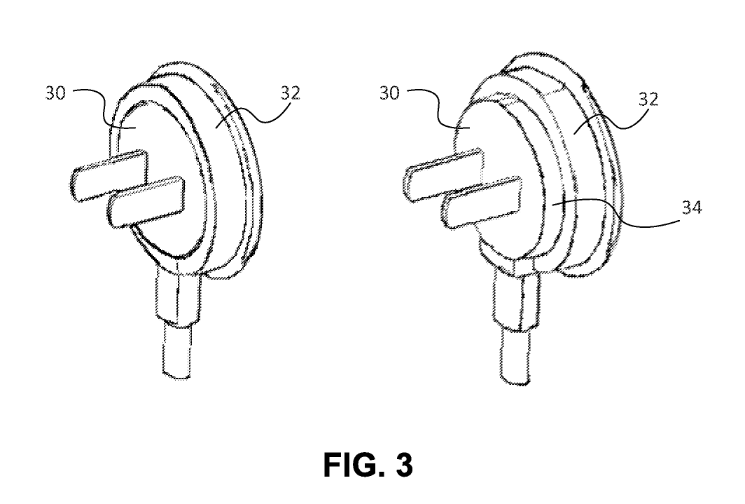

### DETAILED DESCRIPTION OF ILLUSTRATIVE EMBODIMENTS

The present disclosure describes novel extraction components that may be implemented in electrical plugs, particularly slim electrical plugs where it is desirable to reduce the profile of the plug extending from an outlet socket. The extraction components include components of the plug that are retractable, so as to enlarge the graspable area of the plug, when in use, and collapsible, so as to reduce the profile of the plug, when not in use. The extraction components enable the plug to be pulled straight out of an outlet socket instead of at an angle and do not require hinges for a handle.

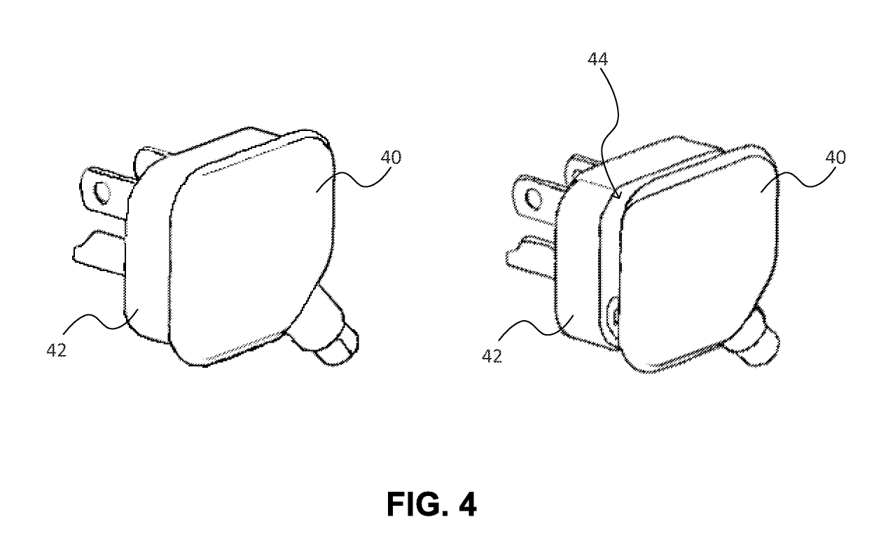

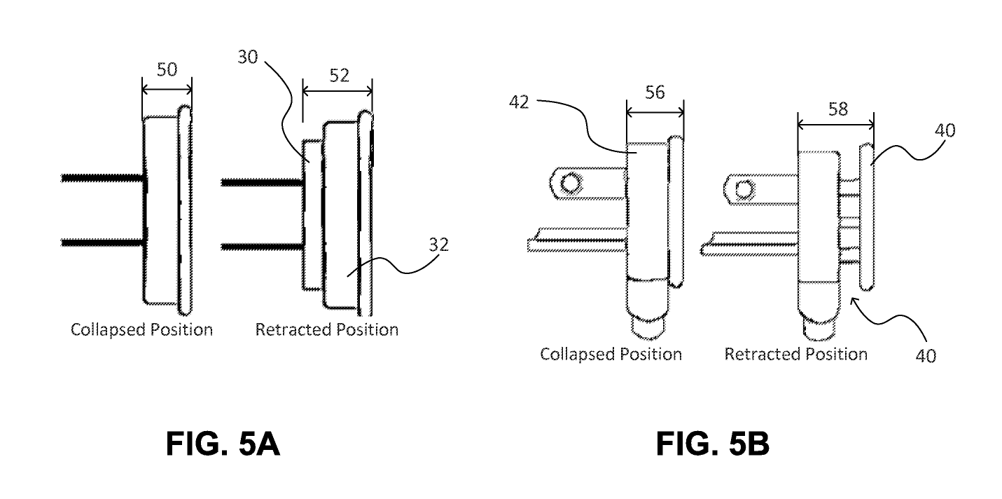

A first embodiment is illustrated in FIG. 3 and a second embodiment is illustrated in FIG. 4, each of which is described in much greater detail below. Both embodiments may be implemented in plugs in accordance with standards in any country, such as China, Japan, United States, and Taiwan. When retracted, the extraction component of both embodiments increases the profile by a number of millimeters, and thereby increases the surface area of the plug, which makes it easier for a user to grip the plug and extract it from an outlet socket.

In FIG. 3, the extraction component 32 surrounds the housing 30 for a China 2-pin plug. The housing 30 stays in place when the extraction component 32 is retracted and collapsed. When retracted, the extraction component 32 increases the graspable area 34 around the housing 30. The nearly full round body of the extraction component 32 of FIG. 3, which may be assembled using ultrasonic welding, helps to properly guide the extraction component along the housing 30 during retraction and collapse.

In FIG. 4, the extraction component is a cap 40 on top of the overmold 42 for U.S. 3-pin plug. The overmold 42 stays in place when the extraction component 40 is retracted and collapsed. When retracted, the extraction component 40 increases the graspable area 44 between the overmold and the extraction component 40. The extraction component 40 of FIG. 4, which may be assembled by press-fitting guide poles into pre-defined slots, includes multiple guide poles that help to properly guide the extraction component 40 away from the overmold 42 during retraction and collapse.

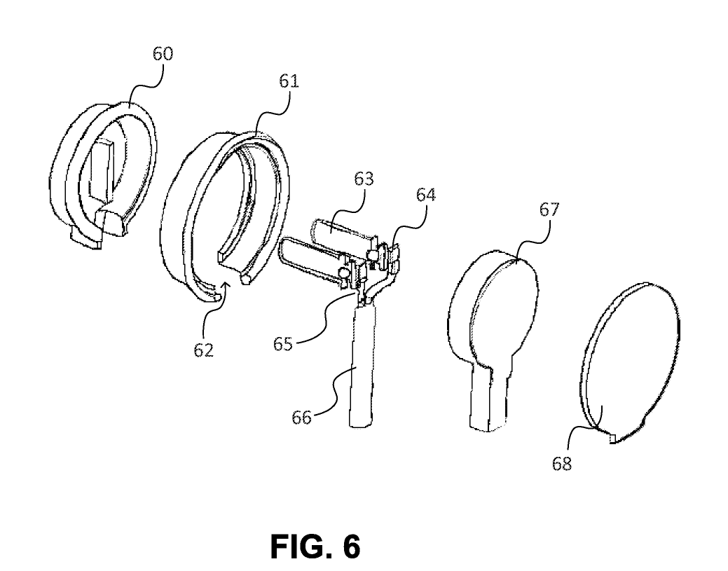

FIGS. 5A and 5B further illustrate the profiles of the plugs from FIG. 3 and FIG. 4, respectively, when collapsed and when retracted. As illustrated in FIG. 5A, in an embodiment, the profile dimension 50 of the plug that would extend from the outside of an outlet socket into which the plug is inserted is approximately 10 mm, and when retracted, the profile dimension 52 is approximately 14 mm. As illustrated in FIG. 5B, in an embodiment, the profile dimension 56 of the plug that would extend from the outside of an outlet socket into which the plug is inserted is approximately 12 mm, and when retracted, the profile dimension 58 is approximately 16.5 mm. The dimensions associated with both plugs are merely exemplary. Either embodiment may be constructed with other dimensions without departing from the spirit and intent of the present disclosure.

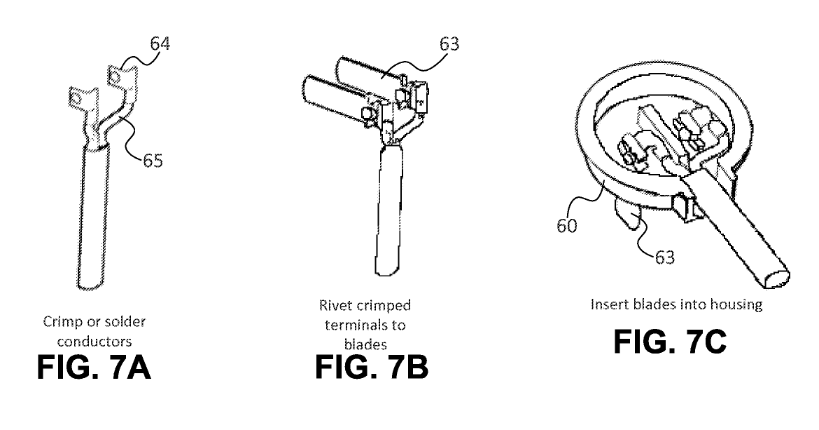

FIG. 6 is an exploded view of the plug illustrated in FIG. 3. The plug includes a housing 60, over which is inserted the extraction component 61. The blades 63 of the plug are then inserted into thru-holes (not shown) of the housing 60. Each of the blades 63 are connected to the crimped terminal 64 of the ends of the conductors 65 from the 2-core flat cable 66. The cable 66 passes through an opening 62 formed in the walls of the extraction component 61. Assembly of blades 63, crimped terminals 64, conductors 65, and part of the cable 66, including the portion of the cable 66 extending into the housing 60 is then overmolded by an overmold 67. A cap 68 is then placed within a rimmed upper portion of the extraction component 61 so as to cover the upper portion of the housing 60 and the overmold 67. Finally, the cap 68 is ultrasonically welded to the upper rim of the extraction component 61. The housing 60, extraction component 61, overmold 67 and cap 68 may be formed from an insulating plastic material.

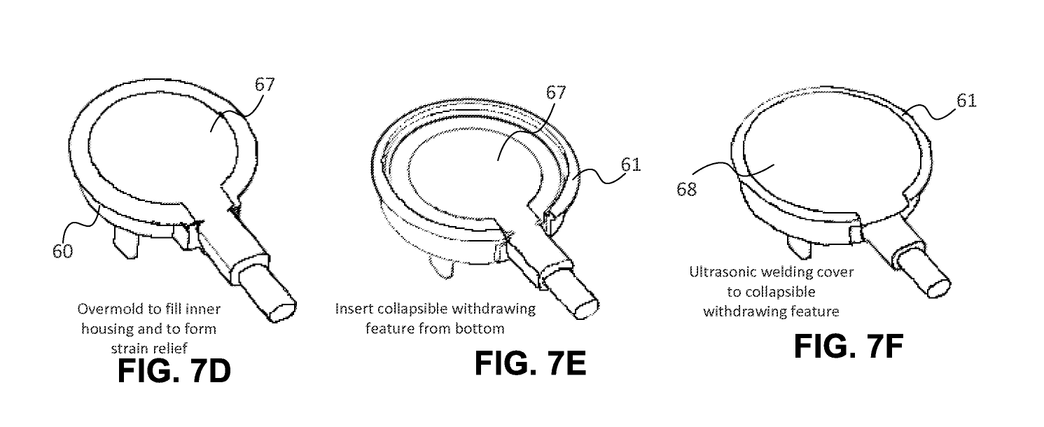

The assembly steps of the plug illustrated in FIG. 6 is further illustrated in FIGS. 7A-7F. In FIG. 7A, the conductors 65 are crimped or soldered to terminals 64. Then, in FIG. 7B, the terminals 64 are rivet crimped to the blades 63. In FIG. 7C, the blades 63 are then inserted into the housing 60. In the next step, as depicted in FIG. 7D, the overmold 67 is flowed into the housing 60 so as to fill the interior of the housing 60 and to form a strain relief for the conductors 65 and their connection to the blades 63. The extraction component 61 is then inserted over the housing 60 from the bottom side of the plug in FIG. 7E. Finally in FIG. 7F, the cap 68 is placed on top of and covers the overmold 67 and housing 60. The cap 68 may be ultrasonically welded to the extraction component 61.

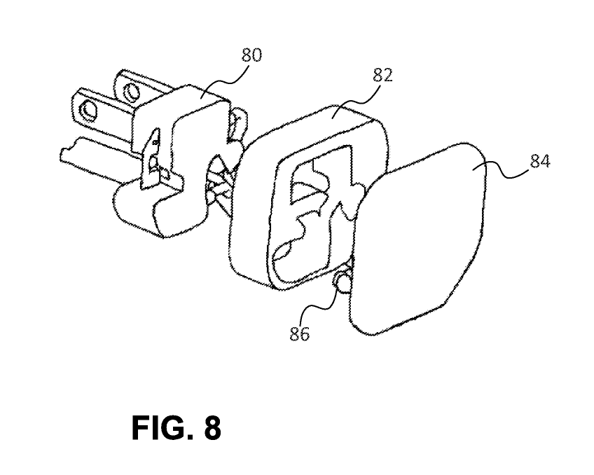

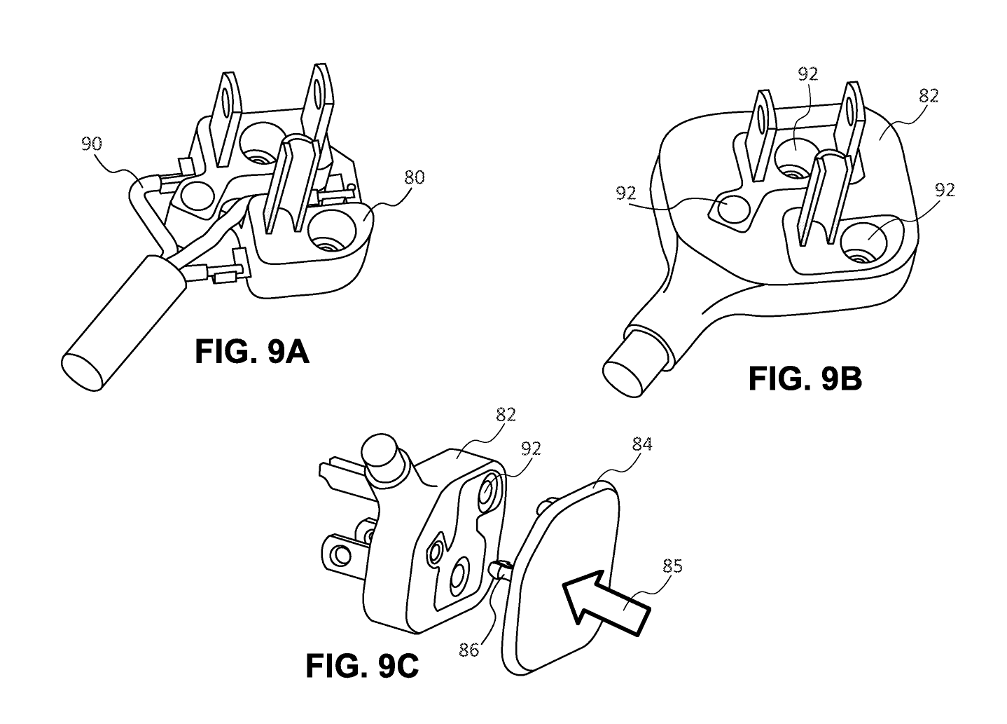

FIG. 8 is a partially exploded view of the plug illustrated in FIG. 4. The blades and earth pin of the 3-pin plug are formed within a 3-pin bridge 80, around which is formed the overmold 82. The extraction component 84, in the form of a cap, is then attached to the overmold with snap-fit pins 86. FIGS. 9A-9C illustrate assembly steps associated with assembling the plug illustrated in FIG. 8. In the first step of FIG. 9A, conductors 90 are crimped or soldered to the S-pin bridge 80. In FIG. 9B, the overmold 82 is then formed around the 3-pin bridge 80, leaving a number of openings 92 into which the snap-fit pins 86 of the extraction component 84 may be inserted. In FIG. 9C, the extraction component 84 is pressed on in the direction of the arrow 85 until the snap-fit pins 86 lock in place within openings 92.

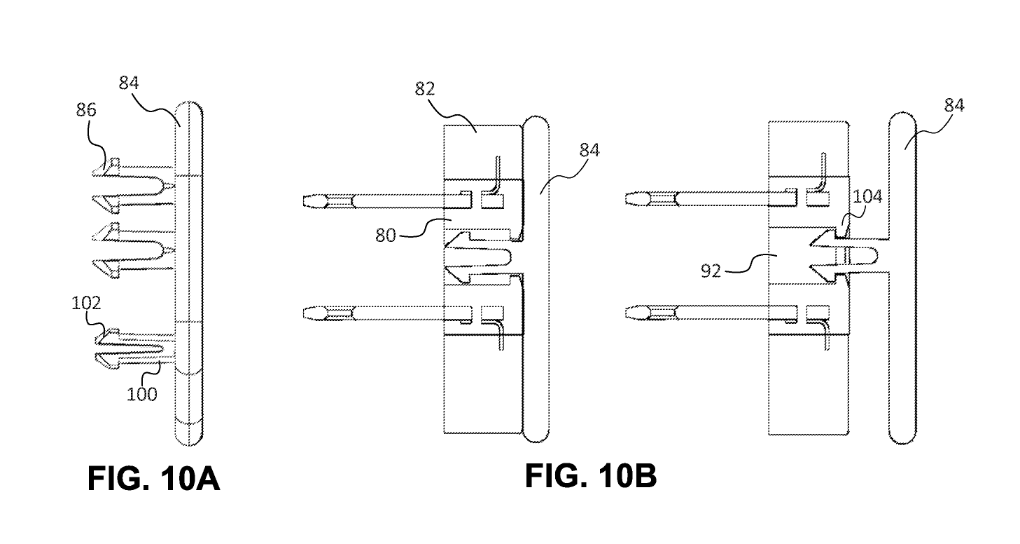

FIG. 10A is a side view of the extraction component 84 of FIG. 9 further illustrating the snap-fit pins 86, which include three guide poles 100, each of which includes a snap-fit component 102 at its end. The guide poles serve to guide the extraction component 84 and to prevent wobbling of the extraction components 84 when it is retracted. FIG. 10B are cross-sectional illustrations of the plug of FIG. 4 in the collapsed and the retracted position. As noted, the snap-fit pins 86 of the extraction component 84 move up and down within openings 92 formed in the 3-pin bridge, with the retraction limit of the extraction component 84 being defined by the stops 104 of the openings 92.

As described above, in one embodiment, the extraction component is a slidable cover substantially surrounding the periphery of a housing holding the pins and wiring of the plug within an overmold. In the second embodiment, the extraction component is a slidable cap connected to a pin bridge that is surrounded by an overmold. A number of openings are formed within the pin bridge, each opening including a stopper that limits the retraction of the extraction component. The extraction components includes a number of snap-fit pins that are each inserted into the openings beyond the stoppers, at which point the snap-fit ends of the pins expand and hold pins within the openings.

The embodiments of the plugs illustrated herein have a number of useful components:

1. Users can use multiple fingers to grip around the entire extraction component, instead of one finger through a pull tab, making it easier to withdraw the plug and ensuring that the plug is extracted straight from the outlet socket into which it is inserted, instead of being pulled at an angle.

2. The embodiments are more convenient during extraction of the plug because each embodiment uses a pull-pull method instead of flip-pull method. The pull-pull method only requires the user to exert a small pull force in order to first pull the extraction component out so it may be used and a second pull force in order to pull the plug from outlet socket. In most cases, both pulling actions are performed at once since both are moving in same direction. The flip-pull method requires a handle to first be flipped away from the plug housing and then the handle is pulled by the user to extract the plug from the outlet socket.

In an embodiment, a collapsible low profile electrical plug comprises: a plug component including two or more electrical pins configured to linearly engage an electrical socket, each of the two or more electrical pins being coupled to a conductor at a coupling point, the coupling point to each conductor and a portion of the conductor being at least partially surrounded by an overmold; and an extraction component configured to co-linearly (with the direction of engaging the electrical socket) engage the plug component, the extraction component having a collapsed position that reduces a profile of the electrical plug and a retracted position that increases the profile of the electrical plug.

In an embodiment, the plug component further includes a housing having an interior configured to hold the conductor and each of the two or more electrical pins at least at the coupling point, and the overmold fills at least a portion of the interior of the housing. In an embodiment, the plug component further includes a cap covering the overmold. In an embodiment, the cap is ultrasonically welded to the extraction component. In an embodiment, the extraction component substantially surrounds the housing and includes a lower rim, the extraction component slidably engaging the housing, which includes an upper rim, and having a retraction limit defined by when the lower rim of the extraction component contacts the upper rim of the housing.

In an embodiment, the plug component further includes a bridge configured to hold the conductor and each of the two or more electrical pins at least at the coupling point, and the overmold substantially surrounds the bridge. In an embodiment, the bridge forms a plurality of openings within the bridge that are not filled with the overmold. In an embodiment, the extraction component includes a cap having a plurality of pins configured to engage the plurality of openings. In an embodiment, the bridge forms a rim at a mouth of each opening among the plurality of openings. Additionally, each pin among the plurality of pins includes a snap-fit element configured to slide past the rim of each opening and expand within the opening to prevent the pin from being removed from the opening when the cap is retracted from the plug component.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain components, elements, and/or steps. Thus, such conditional language is not generally intended to imply that components, elements and/or steps are in any way required for one or more examples or that one or more examples necessarily include logic for deciding, with or without author input or prompting, whether these components, elements and/or steps are included or are to be performed in any particular example. The terms “comprising,” “including,” “having,” and the like are synonymous and are used inclusively, in an open-ended fashion, and do not exclude additional elements, components, acts, operations, and so forth. Also, the term “or” is used in its inclusive sense (and not in its exclusive sense) so that when used, for example, to connect a list of elements, the term “or” means one, some, or all of the elements in the list.

In general, the various components and processes described above may be used independently of one another, or may be combined in different ways. All possible combinations and subcombinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. The example systems and components described herein may be configured differently than described. For example, elements may be added to, removed from, or rearranged compared to the disclosed examples.

While certain example or illustrative examples have been described, these examples have been presented by way of example only, and are not intended to limit the scope of the subject matter disclosed herein. Indeed, the novel methods and systems described herein may be embodied in a variety of other forms. The accompanying claims and their equivalents are intended to cover such forms or modifications as would fall within the scope and spirit of certain of the subject matter disclosed herein.

What is claimed:

1. A collapsible low profile electrical plug, comprising:
a plug component including two or more electrical pins configured to linearly engage an electrical socket, each of the two or more electrical pins being coupled to a conductor at a coupling point, the coupling point to each conductor and a portion of the conductor being at least partially surrounded by an overmold; and
an extraction component configured to co-linearly engage the plug component, the extraction component having a collapsed position that reduces a profile of the electrical plug and a retracted position that increases the profile of the electrical plug.

2. The collapsible low profile electrical plug as recited in claim 1, wherein the plug component further includes a housing having an interior configured to hold the conductor and each of the two or more electrical pins at least at the coupling point, and wherein the overmold fills at least a portion of the interior of the housing.

3. The collapsible low profile electrical plug as recited in claim 2, wherein the extraction component further includes a cap covering the overmold.

4. The collapsible low profile electrical plug as recited in claim 3, wherein the cap is ultrasonically welded to the extraction component.

5. The collapsible low profile electrical plug as recited in claim 3, wherein the extraction component substantially surrounds the housing and includes a lower rim, the extraction component slidably engaging the housing, wherein the housing includes an upper rim, and wherein the extraction component has a retraction limit defined by when the lower rim of the extraction component contacts the upper rim of the housing.

6. The collapsible low profile electrical plug as recited in claim 1, wherein the plug component further includes a bridge configured to hold the conductor and each of the two or more electrical pins at least at the coupling point, and wherein the overmold substantially surrounds the bridge.

7. The collapsible low profile electrical plug as recited in claim 6, wherein the bridge forms a plurality of openings within the bridge that are not filled with the overmold.

8. The collapsible low profile electrical plug as recited in claim 7, wherein the extraction component includes a cap having a plurality of pins configured to engage the plurality of openings.

9. The collapsible low profile electrical plug as recited in claim 8, wherein the bridge forms a rim at a mouth of each opening among the plurality of openings, wherein each pin among the plurality of pins includes a snap-fit element configured to slide past the rim of each opening and expand within the opening to prevent the pin from being removed from the opening when the cap is retracted from the plug component.
